(19) United States
(12) Patent Application Publication
(10) Pub. No.: US 2025/0260504 A1
(43) Pub. Date: Aug. 14, 2025

(54) DETECTION OF JAMMING SIGNALS IN A COMMUNICATION NETWORK

(71) Applicant: Telefonaktiebolaget LM Ericsson (publ), Stockholm (SE)

(72) Inventors: Adrian GARCIA RODRIGUEZ, Paris (FR); Illyyne SAFFAR, Le plessis-Robinson (FR); Laëtitia BARINGTHON, Palaiseau (FR); Pegah ALIZADEH, Paris (FR); Abdoulaye BAGAYOKO, La garenne colombes (FR)

(73) Assignee: Telefonaktiebolaget LM Ericsson (publ), Stockholm (SE)

(21) Appl. No.: 18/994,594

(22) PCT Filed: Aug. 23, 2022
(86) PCT No.: PCT/EP2022/073502

§ 371 Date: Jan. 14, 2025

(51) Int. Cl. H04K 3/00; G06N 20/00

(52) U.S. Cl. CPC H04K 3/22; G06N 20/00

(57) ABSTRACT

A method (200) for facilitating detection of jamming signals on the Physical layer of a communication network is disclosed. The method is performed by a first node of the communication network and comprises receiving, from each of a plurality of second nodes, a value of at least one parameter characterizing the respective second node (210), and obtaining measurement data of radio signals in a coverage area of the first node (220). The method further comprises determining, from at least the received parameter values, a number of source ML models to be trained to detect jamming signals (230), and training the determined number of source ML models using the obtained measurement data of radio signals in a coverage area of the first node (240). The method further comprises, for each trained source ML model, causing a target ML model to be generated from the source ML model using a Transfer Learning process (250), causing each of the plurality of second nodes to use at least one of the target ML models to detect jamming signals on the Physical layer of the communication network (260).

### TECHNICAL FIELD

The present disclosure relates to a method for facilitating detection of jamming signals on the Physical layer of a communication network, and to a method for detection of such signals. The methods may be performed by a first and second nodes of the communication network respectively. The present disclosure also relates to a first node, a second node, and to a computer program product configured, when run on a computer, to carry out methods for facilitating detection of jamming signals and for detection of such signals.

### BACKGROUND

A jamming attack is a deliberate interference with radio transmissions in order to corrupt a targeted signal beyond recovery. In the physical layer (PHY), a jammer acts by decreasing the signal-to-noise ratio at the receiver end of the communication. Jamming attacks represent a significant challenge to wireless communications communication networks.

PHY jamming detection techniques based on artificial intelligence (AI) or machine learning (ML) use pre-trained models to identify jammers based on baseband quadrature (IQ) signals. In order to maximize the performance of jamming detection techniques, all nodes in the network should ideally implement these techniques. This is because jammers may only target specific base stations (BSs) or user equipment (UEs). FIG. 1 illustrates a typical jammer attack, with the larger circle showing the coverage area of a Macro base station (BS), and the smaller circle showing the coverage area of the jamming signal. The jammer attack only affects a subset of wireless nodes, including the small cell and UE that are within its coverage area.

Different options exist for the training of jamming detection models, including centralized training of a model that is then distributed to nodes within the network, and local training of individual models at the nodes where the models will be used. Both of these options are associated with disadvantages.

With reference to centralized training, IQ signals generate an excessive amount of data, which makes their transportation over the network for processing on a remote central server a difficult process that is also expensive from the point of resource usage. Additionally, in practical systems there exists a heterogeneity of devices with different computing, energy, and communication capabilities, such as macro BSs, small cells, and UEs. Even within a single type of device, there exists a variety of macro BSs and small cell models with different bandwidths, number of antennas, or hardware features. The use of the same centrally trained AI/ML model across all the network nodes is not therefore practical, as training a centralized model that generalizes for all different types of nodes and environmental circumstances, if it can be achieved, is likely to decrease the model's accuracy to an unacceptable level.

An alternative approach is to train jamming detection models at the network edge. However, training independent models on a per-node basis may also be non feasible owing to the limited amount of measurement data available on each node, especially in setups where jammers appear in a very sporadic manner, which is the most typical case. In addition, many nodes may be unable to execute the complete AI/ML model training process, as it may require a large amount of time, memory, and computing resources.

Transfer learning (TL) is a technique that may be used to improve the learning of a target predictive function in a target domain by leveraging a function learned in a related but different source domain. In C. Han and Y. Niu, “Multi-regional anti-jamming communication scheme based on transfer learning and Q learning.” KSII Transactions on Internet & Information Systems, vol. 13, no. 7, pp. 3333-3350, July 2019, the authors explore the use of TL in the context of wireless security, seeking to speed up the reinforcement learning process in a variety of jamming-related setups. However, the methods disclosed fail to address heterogeneous deployment scenarios involving a range of devices with different computing, energy, and communication capabilities, all of which may be required to perform jamming detection. Consequently, poor jamming performance in such scenarios may still be expected.

### SUMMARY

It is an aim of the present disclosure to provide methods, first and second nodes, and a computer program product which at least partially address one or more of the challenges mentioned above. It is a further aim of the present disclosure to provide methods, and first and second nodes which cooperate to facilitate detection of jamming signals in a communication network.

According to a first aspect of the present disclosure, there is provided a method for facilitating detection, at a plurality of second nodes of a communication network, of jamming signals on the Physical layer of the communication network. The method is performed by a first node of the communication network and comprises receiving, from each of the plurality of second nodes, a value of at least one parameter characterizing the respective second node, and obtaining measurement data of radio signals in a coverage area of the first node. The method further comprises determining, from at least the received parameter values, a number of source Machine Learning (ML) models to be trained to detect jamming signals, and training the determined number of source ML models using the obtained measurement data of radio signals in a coverage area of the first node. The method further comprises, for each trained source ML model, causing a target ML model to be generated from the source ML model using a Transfer Learning process, and causing each of the plurality of second nodes to use at least one of the target ML models to detect jamming signals on the Physical layer of the communication network.

According to another aspect of the present disclosure, there is provided a method for detecting, at a second node of a communication network, jamming signals on the Physical layer of the communication network. The method is performed by the second node of the communication network and comprises sending, to a first node of the communication network, a value of at least one parameter characterizing the second node, and using a target ML model to detect jamming signals on the Physical layer of the communication network. According to the method, the target ML model has been generated from a source ML model using Transfer Learning, and the source ML model has been trained by the first node using measurement data of radio signals in a coverage area of the first node.

According to another aspect of the present disclosure, there is provided a computer program product comprising a computer readable non-transitory medium, the computer readable medium having computer readable code embodied therein, the computer readable code being configured such that, on execution by a suitable computer or processor, the computer or processor is caused to perform a method according to any one of the aspects or examples of the present disclosure.

According to another aspect of the present disclosure, there is provided a first node in a communication network, the first node for facilitating detection, at a plurality of second nodes of the communication network, of jamming signals on the Physical layer of the communication network. The first node comprises processing circuitry configured to cause the first node to receive, from each of the plurality of second nodes, a value of at least one parameter characterizing the respective second node, and to obtain measurement data of radio signals in a coverage area of the first node. The processing circuitry is further configured to cause the first node to determine, from at least the received parameter values, a number of source ML models to be trained to detect jamming signals and to train the determined number of source ML models using the obtained measurement data of radio signals in a coverage area of the first node. The processing circuitry is further configured to cause the first node to, for each trained source ML model, cause a target ML model to be generated from the source ML model using Transfer Learning, and to cause each of the plurality of second nodes to use at least one of the target ML models to detect jamming signals on the Physical layer of the communication network.

According to another aspect of the present disclosure, there is provided a second node of a communication network, the second node for detecting jamming signals on the Physical layer of the communication network. The second node comprises processing circuitry configured to cause the second node to send, to a first node of the communication network, a value of at least one parameter characterizing the second node, and to use a target ML model to detect jamming signals on the Physical layer of the communication network. The target ML model has been generated from a source ML model using Transfer Learning, and the source ML model has been trained by the first node using measurement data of radio signals in a coverage area of the first node.

Aspects of the present disclosure thus provide methods and nodes/modules that enable the transfer of ML models for PHY-based jamming detection across network nodes with different characteristics. The model executed by the second node has been trained using transfer learning and considering the particular characteristics of the second node. In this manner, an ML model for jamming detection can be tailored to each of a plurality of potentially different second nodes in the network, enhancing model accuracy, at each second node. Examples methods and nodes disclosed herein also ensure reduced training time and complexity of the ML models for PHY-based jamming detection at the second nodes. Further examples of the present disclosure address the question of optimising and coordinating data acquisition for TL model training and inference purposes, which is particularly useful in networks comprising a plurality of second nodes having different computing, energy, and communication capabilities (including for example macro BSs, small cells, and UEs). According to some examples of the present discourse, methods and nodes presented herein may be particularly useful in private networks, in which an adequate detection of jammers is often considered to be a critical network requirement.

### BRIEF DESCRIPTION OF THE DRAWINGS

For a better understanding of the present disclosure, and to show more clearly how it may be carried into effect, reference will now be made, by way of example, to the following drawings in which:

FIG. 1 illustrates a typical jammer attack;

FIG. 2 is a flow chart illustrating process steps in a method for facilitating detection of jamming signals in a communication network;

FIGS. 3ai to 3d show flow charts illustrating another example of a method for facilitating detection of jamming signals in a communication network;

FIG. 4 is a flow chart illustrating process steps in a method for detecting jamming signals in a communication network;

FIGS. 5ai to 5b show flow charts illustrating another example of a method for detecting jamming signals in a communication;

FIG. 6 network is a block diagram illustrating functional modules in an example first node;

FIG. 7 is a block diagram illustrating functional modules in another example first node;

FIG. 8 is a block diagram illustrating functional modules in an example second node;

FIG. 9 Is a block diagram illustrating functional modules in another example second node;

FIG. 10 is a sequence diagram illustrating a process flow for implementing example methods according to the present disclosure;

FIG. 11 illustrates alternating empty time/frequency resource elements for facilitating jamming detection;

FIG. 12 illustrates transfer learning from different numbers of source ML models; and

FIG. 13 illustrates transfer learning from an unsupervised source model.

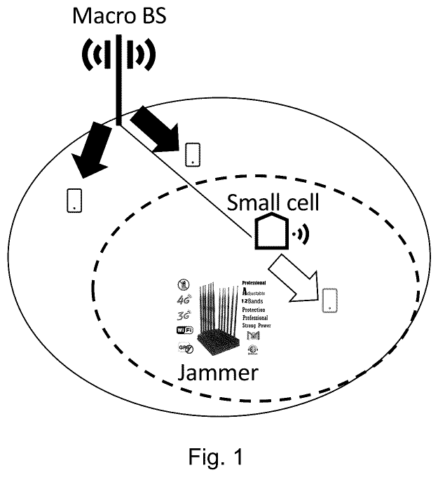

### DETAILED DESCRIPTION

Examples of the present disclosure propose methods that enable the transfer of ML models for PHY-based jamming detection between nodes with different features, capabilities, and environment surroundings. This may be achieved by executing a series of actions during the training and deployment of the ML models, which actions seek to cause a source domain for transfer learning to resemble as closely as possible a target domain for the transfer learning. In some examples, these actions may include obtaining training data for training of a source model, and for transfer learning, on the same set of reserved resources.

In one example method according to the present disclosure, a central or first node, which may be a Radio Access Network (RAN) node such as a Macro BS, communicates to dependent or second nodes, which may for example be small cells or UEs, that they should reserve a subset of time/frequency resource elements (REs) at least for jamming detection purposes. In some examples, these REs will not have intended uplink transmissions from associated UEs, that is they may be empty REs. The same subset of REs may be reserved by the central or first node. The central node receives from the dependent nodes information on their node-specific characteristics, and may in some examples also receive training data from dependent nodes where ML models for PHY-based jamming detection will be executed. The training data acquired by both the central and dependent nodes may include at least the signals measured in the reserved subset of REs.

The central node determines how many source ML models to train, and trains at least one ML model for PHY-based jamming detection. The central node may seek to mimic the specific behaviour/features of dependent nodes in selecting training data for training the model, and may in some examples use the dependent node data in addition to its own data. This may facilitate transfer learning, as it will make the source and target domains more similar, for example by removing large differences which may be expected in the intended received signals (useful network traffic) of macro and small cell BSs. A target ML model is then generated from the source ML model, either by the central node or by a dependent node. The target model is then transferred to a dependent node (if generated by the central node), and is used by the dependent node to detect jamming signals. In some examples, in order to improve model performance, the inference data used as input to the ML model may be collected from signals measured in the above-discussed reserved subset of empty REs.

In some examples of the present disclosure, parameters or features in addition to PHY-specific parameters may be used to enhance the performance of the jamming detection models. An example of such parameters could be layer 3 RSRP measurements (for example those observed in the past).

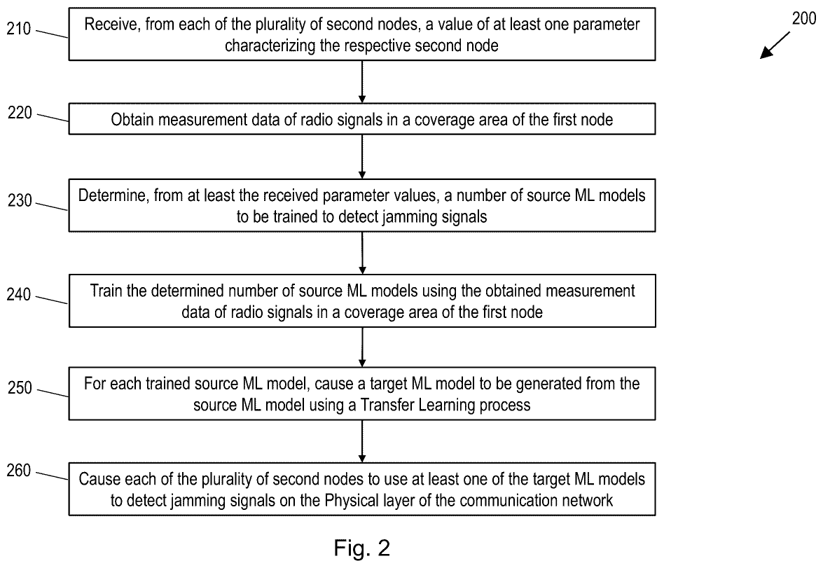

FIG. 2 is a flow chart illustrating process steps in a method 200 for facilitating detection, at a plurality of second nodes of a communication network, of jamming signals on the Physical layer of the communication network. The method is performed by a first node of the communication network, which may for example be a RAN node. A RAN node of a communication network comprises a node that is operable to transmit, receive, process and/or orchestrate wireless signals. A RAN node may comprise a physical node and/or a virtualised network function. In some examples, a RAN node may comprise a NodeB, eNodeB, gNodeB, etc., or any other current or future implementation of such functionality.

Referring to FIG. 2, the method 200 comprises in a first step 210, receiving, from each of the plurality of second nodes, a value of at least one parameter characterizing the respective second node. The method further comprises, in step 220, obtaining measurement data of radio signals in a coverage area of the first node, and, in step 230, determining, from at least the received parameter values, a number of source Machine Learning (ML) models to be trained to detect jamming signals. In step 240, the method comprises training the determined number of source ML models using the obtained measurement data of radio signals in a coverage area of the first node. The method then comprises, in step 250, for each trained source ML model, causing a target ML model to be generated from the source ML model using a Transfer Learning process, and, in step260, causing each of the plurality of second nodes to use at least one of the target ML models to detect jamming signals on the Physical layer of the communication network.

The method 200 ensures the provision of target ML models that are suitable for use by specific second nodes to detect jamming. These target ML models are generated from one or more source ML models that are centrally trained by the first node. Transfer learning, either performed by the first node and/or by the second nodes, is then used to generate the target ML models for use by the second nodes. It will be appreciated that the number of source ML models may vary from a single source ML model to multiple source ML models, and that for each source ML model, any number of one or more target ML models may be generated. The plurality of second nodes of the communication network may have a range of different characteristics, including different capabilities, and different physical and/or environmental characteristics.

Transfer Learning is well established concept and, for the purposes of the present disclosure, comprises a Machine Learning process in which a source ML model, trained using data from a source domain, is used to improve the learning of a target ML model, wherein the target ML model is to be applied to data in a target domain that is different but related to the source domain. Transfer learning thus transfers the knowledge contained in different but related source and target domains. Various discussions of Transfer Learning exist in literature, including: Zhuang, Fuzhen & Qi, Zhiyuan & Duan, Keyu & Xi, Dongbo & Zhu, Yongchun & Zhu, Hengshu & Xiong, Hui & He, Qing. (2020). A Comprehensive Survey on Transfer Learning. Proceedings of the IEEE. PP. 1-34. 10.1109/JPROC.2020.3004555.

The method 200 involves the generation of source and target ML models. For the purposes of the present disclosure, the term “NIL model” encompasses within its scope the following concepts:
machine Learning algorithms, comprising processes or instructions through which data may be used in a training process to generate a model artefact for performing a given task, or for representing a real-world process or system; and
the model artefact that is created by such a training process, and which comprises the computational architecture that performs the task.

In some examples, the source and target ML models generated according to the method 200 may comprise unsupervised learning models such as 1) autoencoders comprised of an encoder and a decoder which could be, for example, implemented via feedforward neural networks, and/or 2) Generative models such as Generative Adversarial Networks (GANs), and/or 3) machine learning for detecting out-of-distribution data such as unsupervised k-means. In other examples, the source and target ML models generated according to the method 200 may also or alternatively comprise supervised learning models such as 1) feedforward neural network classifiers, and/or 2) models that consider temporality such as Long short-term memory (LSTM) or also convolutional neural network models (CNNs).

The method 200 may be complemented by a method 400 performed by a second node, in which a target ML model is used for jamming detection.

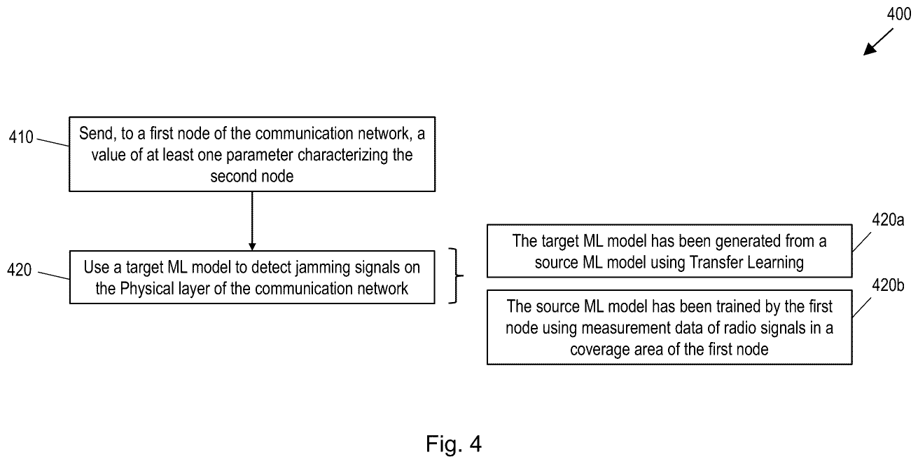

FIG. 4 is a flow chart illustrating process steps in a method 400 for detecting, at a second node of a communication network, jamming signals on the Physical layer of the communication network. The method is performed by the second node of the communication network, which may in some examples be a RAN node or may be a wireless device such as a User Equipment (UE). In some examples in which the second node is a RAN node, the second node may comprise a small cell or other node that is in some manner depended upon or managed by another RAN node.

Referring to FIG. 4, the method 400 comprises, in a first step 410, sending, to a first node of the communication network, a value of at least one parameter characterizing the second node. In step 420, the method 400 comprises using a target ML model to detect jamming signals on the Physical layer of the communication network. As illustrated at 420a and 420b, the target ML model has been generated from a source ML model using Transfer Learning, and the source ML model has been trained by the first node using measurement data of radio signals in a coverage area of the first node.

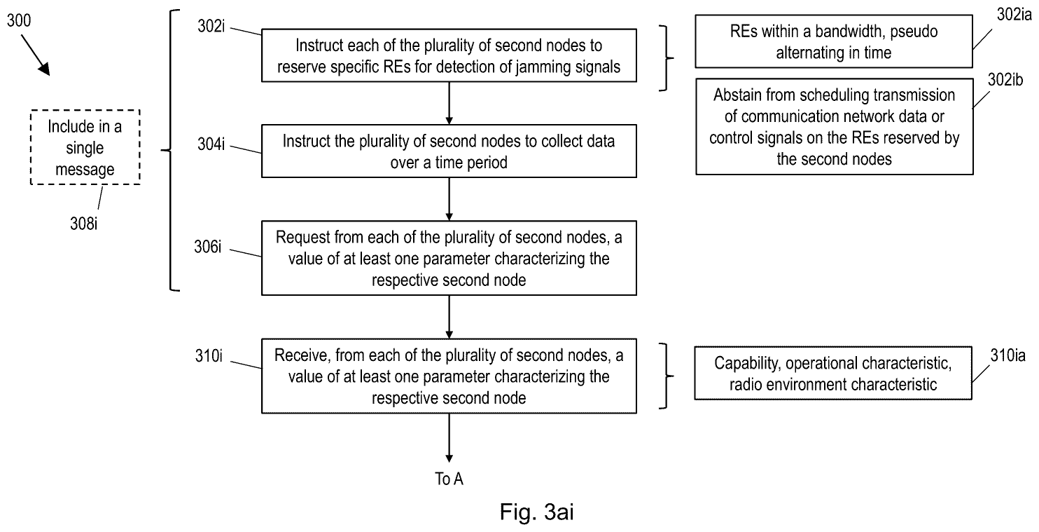

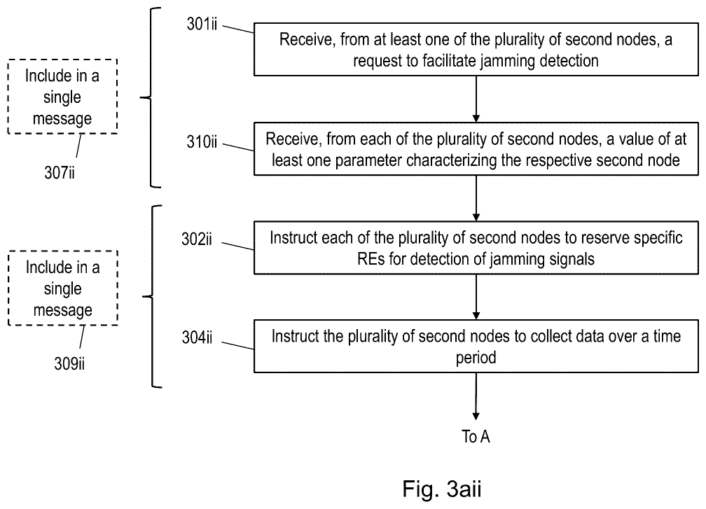

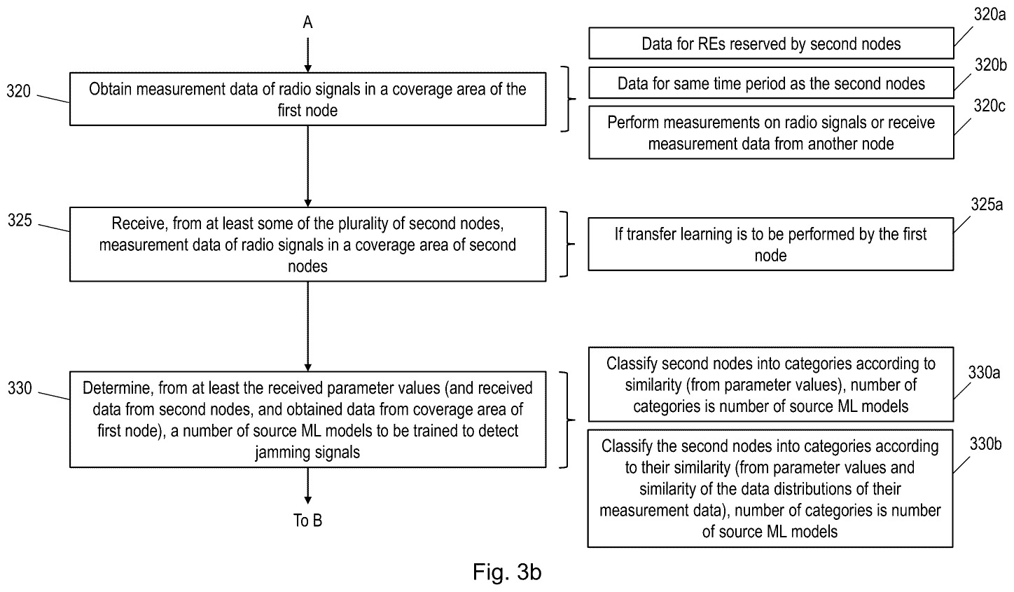

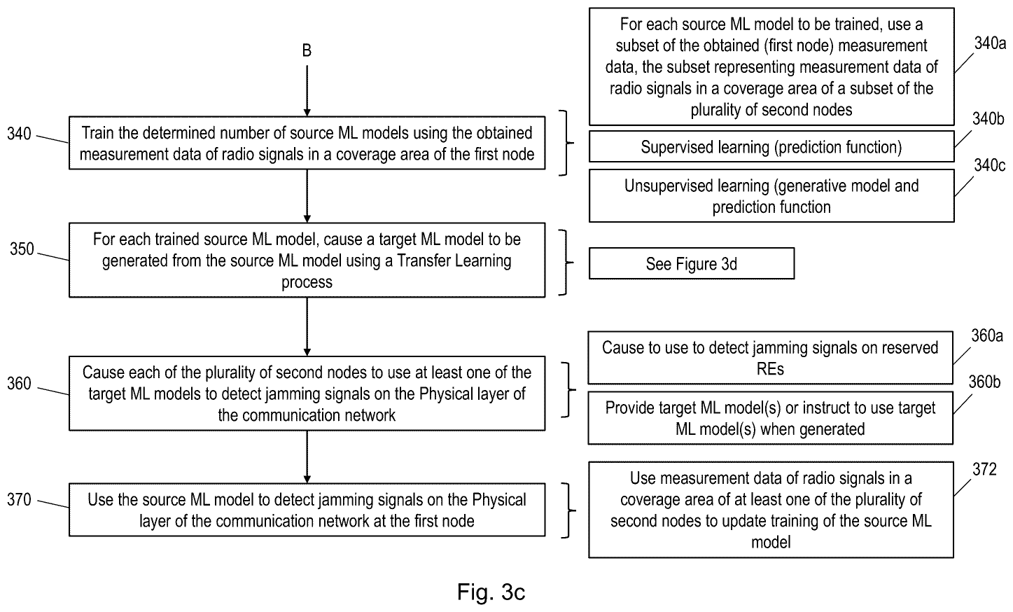

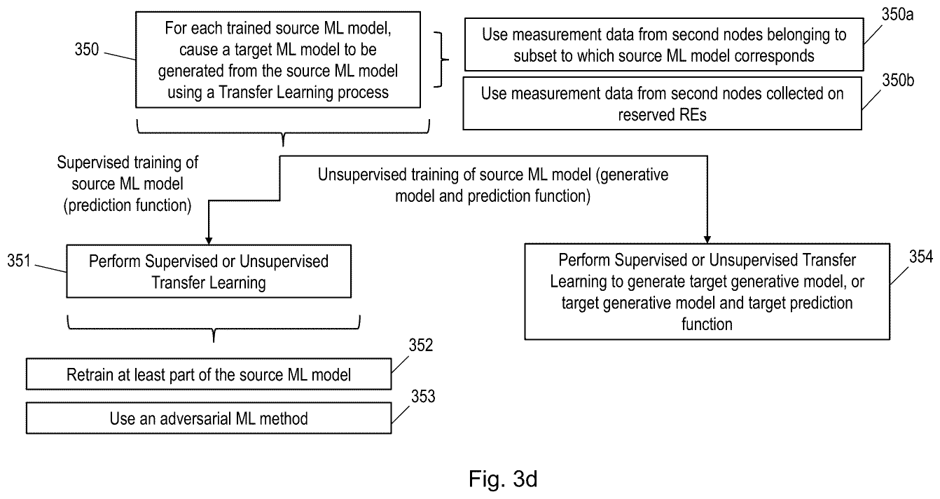

FIGS. 3ai to 3d show flow charts illustrating another example of a method 300 for facilitating detection, at a plurality of second nodes of a communication network, of jamming signals on the Physical layer of the communication network. As for the method 200 discussed above, the method is performed by a first node of the communication network, which may for example be a RAN node. The method 300 illustrates examples of how the steps of the method 200 may be implemented and supplemented to provide the above discussed and additional functionality.

The method 300 may be triggered by the first node or by one or more second nodes. FIG. 3ai illustrates process steps for an example in which the method 300 is triggered or initiated by the first node. FIG. 3aii illustrates process steps for an example in which the method is triggered or initiated by a second node. Following the steps of FIG. 3ai or FIG. 3aii, the first node then continues the method 300 by carrying out the steps set out in FIGS. 3b to 3d.

Referring initially to FIG. 3ai, in a first step 302i, the first node instructs each of the plurality of second nodes to reserve specific Resource Elements (REs) for detection of jamming signals. As illustrated at 302ia, the specific REs to be reserved for detection of jamming signals may be located within a defined bandwidth, and the frequency domain location of the reserved REs alternates pseudo-randomly across time. The defined bandwidth may be a single physical resource element. This may be particularly appropriate for example in the case of narrowband jammer detection, with the pseudo-random allocation facilitating detection in any part of the spectrum and preventing jammer counter measures. As illustrated at 302ib, the first node may abstain from scheduling transmission of communication network data or control signals on the REs reserved by the second nodes for jamming detection.

The first node also instructs the plurality of second nodes to collect data over a time period in step 304i. This may for example comprise sending to the plurality of second nodes a time window, defined in any suitable manner. The first node may in some examples inform the plurality of second nodes that the first node will be performing data collection during the same time window.

In step 306i, the first node requests, from each of the plurality of second nodes, a value of at least one parameter characterizing the respective second node. In some examples, one or more of the instruction to reserve REs, instruction to collect data, indication that the first node will be performing data collection, and/or request for parameter values may be included in the same message, as illustrated at 308i.

In step 310i, the first node receives, from each of the plurality of second nodes, a value of at least one parameter characterizing the respective second node. As illustrated at 310ia, the at least one parameter characterizing the respective second node may comprise at least one of a capability of the second node, an operational characteristic of the second node and/or a radio environment characteristic of the second node. Example parameters may include processing capacity, memory (for example representative of the ability of the node to perform ML model training, transfer learning, etc.), number of antennas, wireless communication bandwidth, noise, etc. Further example parameters may include measurements related to interference such as the average interference power measured in a set of time/frequency resources.

Referring now to FIG. 3aii, and an example in which the method is triggered or initiated by a second node, the first node initially receives from at least one of the plurality of second nodes, a request to facilitate detection of jamming signals in step 301ii. The request may be a request for a target ML model to use for jamming detection, or a request to train a source model that the second node can use for generation of a target ML model using transfer learning.

In step 310ii, the first node receives, from each of the plurality of second nodes, a value of at least one parameter characterizing the respective second node. As discussed above, the at least one parameter characterizing the respective second node may comprise at least one of a capability of the second nod, an operational characteristic of the second node, and/or a radio environment characteristic of the second node.

As illustrated at 307ii, the first node may receive the parameter values with the request message, and may in some examples then inform the second node that the first node is starting data collection, as well as specifying the time window for data collection, as discussed below.

In step 302ii, the first node instructs each of the plurality of second nodes to reserve specific REs for detection of jamming signals, and in step 304ii, the first node instructs the plurality of second nodes to collect data over a time period. The first node may additionally inform the plurality of second nodes that the first node will be performing data collection during the same time period. As illustrated at 309ii, the instructions of steps 302ii and 304ii may in some examples be sent in the same message.

Referring now to FIG. 3b, following carrying out of the steps of FIG. 3ai (method initiated by the first node) or FIG. 3aii (method initiated by tone or more of the second nodes), the first node then, at step 320, obtains measurement data of radio signals in a coverage area of the first node. As illustrated at 320a, this may comprise obtaining measurement data for the REs that the plurality of second nodes have been instructed to reserve for jamming detection. The first node and the plurality of second nodes may thus reserve overlapping REs for jamming detection and data collection. In this manner, performance improvement may be achieved both for the subsequent transfer learning (by making the source and target data domains as similar as possible) and for jamming detection.

In some examples, obtaining measurement data of radio signals in a coverage area of the first node may also comprise obtaining measurement data for the same time period as the second nodes, as illustrated at 320b.

As illustrated at 320c, obtaining measurement data of radio signals in a coverage area of the first node may comprise at least one of performing measurements on radio signals in a coverage area of the first node, and/or receiving the measurement data from another node of the communication network.

In step 325, the first node may receive, from at least some of the plurality of second nodes, measurement data of radio signals in a coverage area of second nodes. As illustrated at 325a, this data may be received for example if the transfer learning is to be performed by the first node. This data will be used by the first node to perform the transfer learning. In examples of the method 300 in which the transfer learning is performed by the second nodes, the second nodes may omit the sending of their measurement data, meaning the first node does not perform step 325. It will be appreciated that the location for carrying out transfer learning (first node or second node) may depend upon a range of factors including the capabilities of the second nodes to carry out such learning, the availability of training data, and possibly other use case or deployment specific factors.

In step 330, the first node determines, from at least the received parameter values, a number of source ML models to be trained to detect jamming signals. As illustrated at 330a, this may comprise classifying the plurality of second nodes into a number of categories according to their similarity as represented by the received parameter values, wherein the number of categories comprises the number of source ML models to be trained.

As illustrated at 330b, determining a number of source ML models to be trained may comprise classifying the plurality of second nodes into a number of categories according to their similarity as represented by the received parameter values and according to a similarity of the data distributions of their measurement data. In such examples, the number of source ML models may be determined from at least the received parameter values and the received measurement data of radio signals in a coverage area of second nodes, as shown at step 330.

In some examples, the number of source ML models to be trained to detect jamming signals may also be determined based on the measurement data of radio signals obtained for a coverage area of the first node. For example, the first node may collect measurement data with distinct features as a consequence of the specific characteristics of two distinct second nodes with a different number of antennas (for example, 4 antennas and 8 antennas). After training a source model with such data, the central node may realize that difference in the number of antennas may not have an impact in the performance of the source model, and simply decide to utilize the same source model (for example, with 4 antennas for lowest complexity) for both second nodes. In another example, source models may be trained for second nodes having the same number of antennas, but the two models are not at all similar because there is some shift in the data owing to the time of collection (for example, day and night) or any other condition impacting this feature. In this example, the measurement data of radio signals obtained for a coverage area of the first node may be used to determine that despite similarity in physical characteristics, different source models are required for two particular second nodes.

It will be appreciated that any one or more of the received parameter values, the received measurement data of radio signals in a coverage area of second nodes, and the measurement data of radio signals obtained for a coverage area of the first node may thus be used to determine a degree of similarity between the source data distributions for the second nodes. If the data distributions do not show significant differences, then a single source ML model may be appropriate. Otherwise, multiple source ML models may be preferable to ensure good performance of the corresponding target ML models for jamming detection.

Referring now to FIG. 3c, the first node then, in step 340, trains the determined number of source ML models using the obtained measurement data of radio signals in a coverage area of the first node. As illustrated at 340a, this may comprise, for each source ML model to be trained, using a subset of the obtained measurement data of radio signals in a coverage area of the first node to train the source ML model, wherein the subset of measurement data is selected to represent measurement data of radio signals in a coverage area of a subset of the plurality of second nodes.

In one example, the subset of measurement data from the first node may be selected such that data from specific antennas, and/or over a specific bandwidth is used, the number of antennas and bandwidth being representative of the number of antennas and bandwidth of the subset of the plurality second nodes. In this context, “representative of” may be understood to refer to a value that is the same as or similar to the relevant value for the subset of the plurality second nodes. In addition, artificial noise may be added to the measurement data of the first node so as to mimic as closely as possible the noise conditions at the subset of the plurality of second nodes. These actions seek to ensure that the training data set for the source ML model is as similar as possible to the training data set for the target ML model(s), thus improving the performance of the transfer learning.

In examples in which a single source ML model is trained, the subset of measurement data from the first node may be selected such that signals from a variety of different antennas, with a variety of different communication bandwidths is used. In addition, noise of a variety of different powers may be added, so as to ensure that the training data set for the source ML model is sufficiently general and representative of conditions across the plurality of second nodes to ensure acceptable performance of the transfer learning, and consequently of the target ML model for jamming detection.

As illustrated at 340b, the source ML model may comprise a prediction function operable to classify a detected radio signal as being either a jamming attack or not a jamming attack. In such examples, the measurement data of radio signals in a coverage area of the first node may include labels classifying the measured signals as a jamming attack or not a jamming attack, and training the determined number of source ML models using the obtained measurement data of radio signals in a coverage area of the first node may comprise using a Supervised Learning method.

As illustrated at 340c, in other examples, training the determined number of source ML models using the obtained measurement data of radio signals in a coverage area of the first node may comprise using an Unsupervised Learning method. In such examples, the source ML model may comprise a generative model operable to estimate the data distribution of non-jamming signals from the measurement data of radio signals in a coverage area of the first node, and a prediction function operable to classify a detected radio signal belonging or not belonging to the estimated data distribution.

In step 350, for each trained source ML model, the first node causes a target ML model to be generated from the source ML model using a Transfer Learning process. In one example, the first node may provide the source ML model to at least one of the plurality of second nodes, and the at least one of the plurality of second nodes then generates a target ML model using Transfer Learning. In other examples, the first node carries out the transfer learning. In such examples, it is assumed that measurement data from coverage areas of the plurality of second nodes is available, for example having been provided to the first node. Steps that may be performed by the first node in order to generate a target ML model from the source ML model using a Transfer Learning process are illustrated in FIG. 3d.

Referring to FIG. 3d, and as illustrated at 350a, each of the trained source ML models may correspond to a subset of the plurality of second nodes, and, for each trained source ML model, causing a target ML model to be generated from the source ML model using Transfer Learning may comprise using, for the Transfer Learning, measurement data of radio signals in a coverage area of second nodes belonging to the subset to which the source ML model corresponds. In this manner, data from the target domain, that is the domain of the relevant subset of second nodes, is used in the transfer learning. It will be appreciated that a source ML model that corresponds to a subset of second nodes comprises a source ML model that is to be used for generation of target ML models that will be used by the subset of second nodes.

As illustrated at 350b, the measurement data of radio signals in a coverage area of second nodes that is used for Transfer Learning may comprise measurement data collected on the reserved resource elements (REs).

As shown in FIG. 3d, generating a target ML model may comprise different steps depending upon the nature of the source ML model and how it was trained (supervised or unsupervised learning). Examples in which the source ML model comprises a prediction function operable to classify a detected radio signal as being either a jamming attack or not a jamming attack, and in which the measurement data of radio signals in a coverage area of the first node includes labels classifying the measured signals as a jamming attack or not a jamming attack, are illustrated on the left of FIG. 3d. In such examples, training the determined number of source ML models using the obtained measurement data of radio signals in a coverage area of the first node may comprise using a Supervised Learning method. Generating a target ML model may subsequently comprise performing at least one of supervised or unsupervised Transfer Learning to generate at least one target ML model from the source ML model, as shown at step 351.

As illustrated at step 352, performing supervised Transfer Learning to generate at least one target ML model from the source ML model may comprise retraining at least a part of the source ML model using the measurement data of radio signals in a coverage area of second nodes belonging to a subset of the plurality of second nodes to which the source ML model corresponds. In the case of a Neural Network (NN), the part that is retrained may be certain layers of the NN, with other layers being unchanged from the source ML model. By retaining a part of the source ML model, the target model is able to converge much faster and with fewer samples than had it been entirely trained from scratch.

As illustrated at 353, performing unsupervised Transfer Learning to generate at least one target ML model from the source ML model may comprise using an adversarial ML method. Examples of such methods may be based on Domain Adversarial Neural Networks (DANNs) or Joint Adaptation Networks (JANs). An advantage of unsupervised transfer learning is that the target converges with high accuracy without the need of collecting labels (which is usually a relatively costly procedure). With unsupervised transfer learning, it is possible to label only the source domain data (for training of the source ML model) while still ensuring good performance of the target ML model.

Examples in which training the determined number of source ML models using the obtained measurement data of radio signals in a coverage area of the first node comprises using an Unsupervised Learning method are illustrated on the right of FIG. 3d. In such examples, the source ML model comprises a generative model operable to estimate the data distribution of non-jamming signals from the measurement data of radio signals in a coverage area of the first node, and a prediction function operable to classify a detected radio signal belonging or not belonging to the estimated data distribution. In such examples, as illustrated at step 354, generated a target ML model from the source ML model using Transfer Learning may comprise using supervised or unsupervised Transfer Learning to generate at least one of
(i) a target generative model to estimate the data distribution of non-jamming signals, or
(ii) a target generative model to estimate the data distribution of non-jamming signals and a target prediction function operable to classify a detected radio signal belonging or not belonging to the estimated data distribution.

Referring again to FIG. 3c, after causing a target ML model to be generated from the source ML model using a Transfer Learning process in step 350, the first node then causes each of the plurality of second nodes to use at least one of the target ML models to detect jamming signals on the Physical layer of the communication network in step 360. As illustrated at 360a, this may comprise causing each of the plurality of second nodes to use at least one of the target ML models to detect jamming signals on the reserved REs. In this manner, the reserved REs are reserved not just for data measurement but also for jamming detection. If these REs are also reserved by the first node, then no other network traffic will be scheduled on these REs. This offers two advantages: firstly, ensuring that no network traffic is present when the measurement data is obtained at both the first and second nodes has the effect of rendering the source and target data domains for transfer learning as similar as possible by ensuring that only jamming signals and signals from other neighbor nodes should be present. This similarity improves the performance of the transfer learning, and consequently results in improved performance of the target ML models. Secondly, ensuring that no network traffic is present when the second nodes use the target ML models to detect jamming signals avoids confusion between genuine network traffic and jamming signals.

As illustrated at 360b, the first node may provide the target ML models to the plurality of second nodes, and/or may instruct the plurality of second nodes to use a target ML model once generated.

In step 370, the first node may use the source ML model to detect jamming signals on the Physical layer of the communication network at the first node. In some examples, as illustrated at 370a, the first node may use measurement data of radio signals in a coverage area of at least one of the plurality of second nodes to update training of the source ML model.

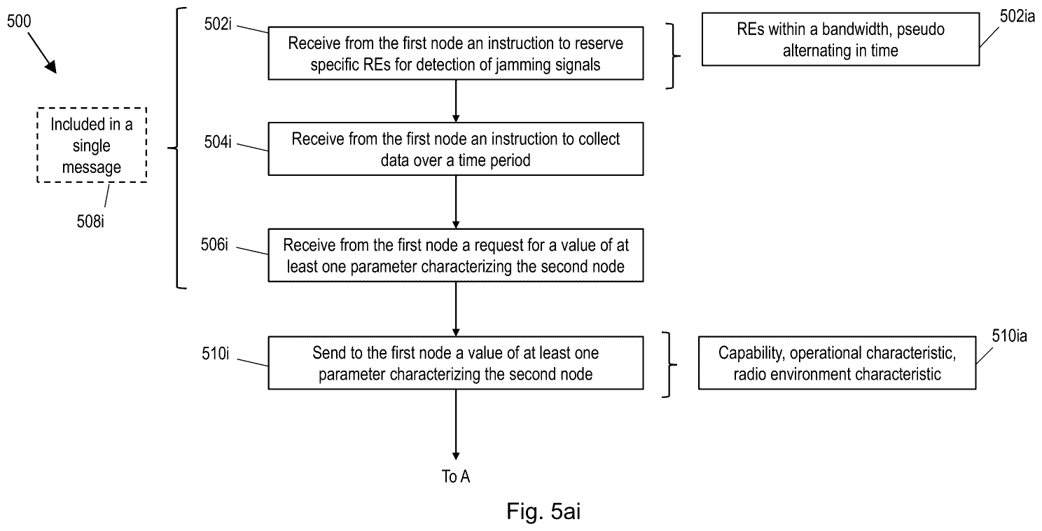

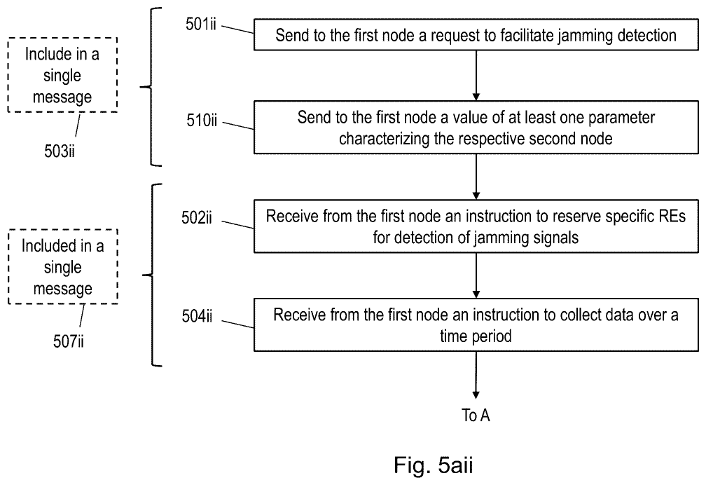

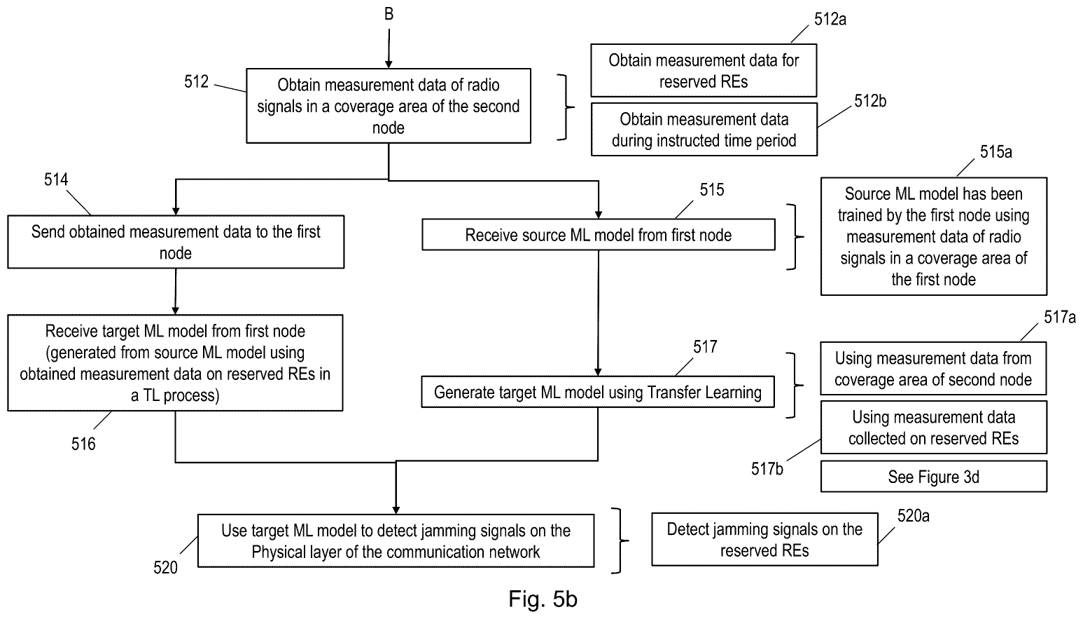

FIGS. 5ai to 5b show flow charts illustrating another example of a method 500 for detecting, at a second node of a communication network, jamming signals on the Physical layer of the communication network. As for the method 300 discussed above, the method 500 is performed by the second node of the communication network, which may in some examples be a RAN node or may be a wireless device such as a User Equipment (UE). In some examples in which the second node is a RAN node, the second node may comprise a small cell or other node that is in some manner depended upon or managed by another RAN node. The method 500 illustrates examples of how the steps of the method 300 may be implemented and supplemented to provide the above discussed and additional functionality.

As discussed above with reference to the method 300, the method 500 may be triggered by a first node of the communication network, by another second node, or by the second node that is performing the method 500. FIG. 5ai illustrates process steps for an example in which the method 500 is triggered or initiated by the first node (in some examples following a preceding initiating message from another second node). FIG. 5aii illustrates process steps for an example in which the method is triggered or initiated by the second node performing the method 500. Following the steps of FIG. 5ai or FIG. 5aii, the second node then continues the method 500 by carrying out the steps set out in FIG. 5b.

Referring initially to FIG. 5ai, in a first step 502i, the second node receives from a first node in the communication network an instruction to reserve specific Resource Elements (REs) for detection of jamming signals. As illustrated at 502ia, the specific REs to be reserved for detection of jamming signals may be located within a defined bandwidth, and the frequency domain location of the reserved REs alternates pseudo-randomly across time. In some examples, the first node may also reserve the same REs for collection of measurement data and detection of jamming signals.

The second node also receives from the first node an instruction to collect data over a time period in step 504i, and receives from the first node a request for a value of at least one parameter characterizing the second node in step 506i. This may trigger the second node to send, in step 510i, a value of at least one parameter characterizing the second node. As illustrated at 510ia, the at least one parameter characterizing the second node may comprise at least one of a capability of the second node, an operational characteristic of the second node, and/or a radio environment characteristic of the second node.

The instruction and requests received in steps 502i, 504i and 506i may in some examples be received in a single message, as shown at 508i.

Referring now to FIG. 5aii, and an example in which the method is triggered or initiated by the second node, the second node initially sends to the first node a request to facilitate detection of jamming signals in step 501ii. The second node then, in step 510ii, sends to the first node a value of at least one parameter characterizing the second node. As illustrated at 503ii, in some examples the request to facilitate jamming detection and the at least one parameter value may be included in the same message.

In step 502ii, the second node receives from the first node an instruction to reserve specific REs for detection of jamming signals. The specific REs to be reserved for detection of jamming signals may be located within a defined bandwidth, and wherein the frequency domain location of the reserved REs alternates pseudo-randomly across time. In step 504ii, the second node receives from the first node an instruction to collect data over a time period. As illustrated at 507ii, the instruction to reserve REs and the instruction to collect data over a time period may be received by the second node in a single message.

Referring now to FIG. 5b, and following completion of the steps in FIG. 5ai or 5aii, the second node then obtains measurement data of radio signals in a coverage area of the second node in step 512. As illustrated at 512a and 512b, the measurement data may be obtained for radio signals on the REs the second node was instructed to reserve, and within the time period specified by the first node. The second node may then perform either steps 514 and 516, or steps 515 and 517, depending upon where the transfer learning to generate a target ML model is to take place (at the first node or at the second node carrying out the method 500). As discussed above with reference to the method 300, it will be appreciated that the location for carrying out transfer learning (first node or second node) may depend upon a range of factors including the capabilities of the second node to carry out such learning, the availability of training data, and possibly other use case or deployment specific factors.

Steps 514 and 516 may be carried out by the second node if the transfer learning is performed at the first node. In step 514, the second node sends to the first node the obtained measurement data of radio signals in a coverage area of the second node. This data will be used by the first node to generate the target ML model in a Transfer Learning process. In step 516, the second node receives the target ML model from the first node, wherein the target ML model has been generated from the source ML model by the first node using Transfer Learning and using the obtained measurement data of radio signals in a coverage area of the second node (provided to the first node in step 514). As illustrated at 516, the measurement data of radio signals in a coverage area of the second node that is used for the Transfer Learning comprises measurement data collected on the reserved REs. In addition, the measurement data of radio signals in a coverage area of the first node is used to train the source ML model from which the target ML model is generated by the first node may have been obtained for the same REs that the second node was instructed to reserve, and over the same time period.

Steps 515 and 517 may be carried out by the second node if the transfer learning is performed at the second node. In step 515, the second node receives the source ML model from the first node. In some examples, the second node may also receive an instruction (which may be implicit), to generate the target ML model and/or to use the generated target ML model for detecting jamming signals. As discussed above, and as shown at 515a, the source ML model has been trained by the first node using measurement data of radio signals in a coverage area of the first node, and which measurement signals may have been obtained by the first node for the same REs that the second node is instructed to reserve, and over the same time period. In step 517, the second node generates the target ML model using Transfer Learning. As illustrated at 517a and 517b, the second node may generate the target ML model using the obtained measurement data of radio signals in a coverage area of the second node (data obtained on the reserved REs and over the instructed time period) in a Transfer Learning process. Steps that may be performed by the second node in order to generate a target ML model from the source ML model using a Transfer Learning process are the same as those that may be performed by the first node when generating the target ML model. Reference is therefore made to FIG. 3d, and to the accompanying description above, for more detail of how this step may be implemented by the second node.

In step 520, having obtained the target ML model either from the first node or by generating the target ML model, the second node then uses the target ML model to detect jamming signals on the Physical layer of the communication network. As illustrated at 520a, this may comprise using the target ML model to detect jamming signals on the reserved REs.

As discussed above, the methods 200 and 300 may be performed by a first node in a communication network, and the present disclosure provides a first node that is adapted to perform any or all of the steps of the above discussed methods. The first node may comprise a physical node such as a computing device, server etc., or may comprise a virtual node. A virtual node may comprise any logical entity, such as a Virtualized Network Function (VNF) which may itself be running in a cloud, edge cloud or fog deployment. The first node may be operable to be instantiated in a cloud based deployment. In one example, the first node may be instantiated in a Cloud RAN deployment. In other examples, the first node may be instantiated in any physical or virtual server in a centralised or cloud based deployment. As discussed above, the first node may comprise a RAN node.

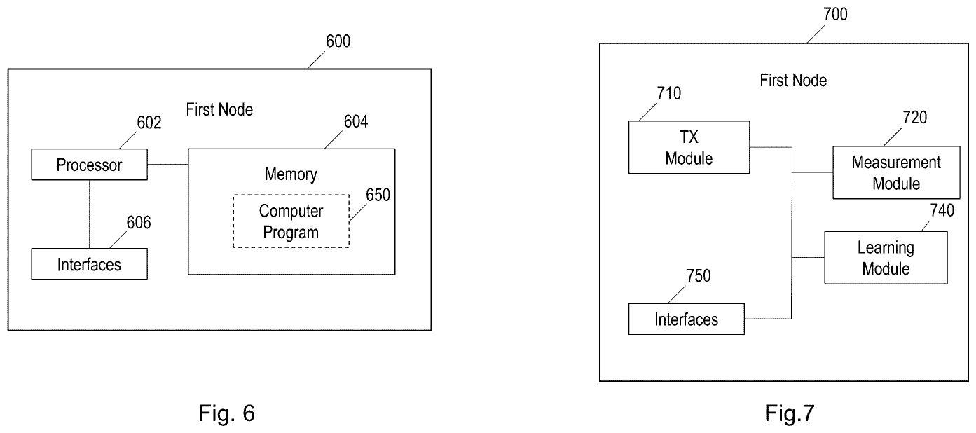

FIG. 6 is a block diagram illustrating an example first node 600 which may implement the method 200 and/or 300, as illustrated in FIGS. 2 and 3ai to 3d, according to examples of the present disclosure, for example on receipt of suitable instructions from a computer program 650. Referring to FIG. 6 the first node 600 comprises a processor or processing circuitry 602, and may comprise a memory 604 and interfaces 606. The processing circuitry 602 is operable to perform some or all of the steps of the method 200 and/or 300 as discussed above with reference to FIGS. 2 and 3ai to 3d. The memory 604 may contain instructions executable by the processing circuitry 602 such that the first node 600 is operable to perform some or all of the steps of the method 200 and/or 300, as illustrated in FIGS. 2 and 3ai to 3d. The instructions may also include instructions for executing one or more telecommunications and/or data communications protocols. The instructions may be stored in the form of the computer program 650. In some examples, the processor or processing circuitry 602 may include one or more microprocessors or microcontrollers, as well as other digital hardware, which may include digital signal processors (DSPs), special-purpose digital logic, etc. The processor or processing circuitry 602 may be implemented by any type of integrated circuit, such as an Application Specific Integrated Circuit (ASIC), Field Programmable Gate Array (FPGA) etc. The memory 604 may include one or several types of memory suitable for the processor, such as read-only memory (ROM), random-access memory, cache memory, flash memory devices, optical storage devices, solid state disk, hard disk drive, etc. The interfaces 606 may be operable to facilitate communication with a second node, and/or with other nodes or modules, over suitable communication channels.

FIG. 7 illustrates functional modules in another example of first node 700 which may execute examples of the methods 200 and/or 300 of the present disclosure, for example according to computer readable instructions received from a computer program. It will be understood that the modules illustrated in FIG. 7 are functional modules, and may be realized in any appropriate combination of hardware and/or software. The modules may comprise one or more processors and may be integrated to any degree.

Referring to FIG. 7, the first node 700 is for facilitating detection, at a plurality of second nodes of a communication network, of jamming signals on the Physical layer of a communication network. The first node 700 comprises a Transceiver module 710 for receiving, from each of the plurality of second nodes, a value of at least one parameter characterizing the respective second node. The first node 700 also comprises a Measurement module 720 for obtaining measurement data of radio signals in a coverage area of the first node. The first node 700 also comprises a Learning module 740 for determining, from at least the received parameter values, a number of source ML models to be trained to detect jamming signals, for training the determined number of source ML models using the obtained measurement data of radio signals in a coverage area of the first node, and, for each trained source ML model, for causing a target ML model to be generated from the source ML model using a Transfer Learning process. The Learning module 740 is also for causing each of the plurality of second nodes to use at least one of the target ML models to detect jamming signals on the Physical layer of the communication network. The first node 700 may further comprise interfaces 750, which may be operable to facilitate communication with a second node, and/or with other nodes or modules, over suitable communication channels.

As discussed above, the methods 400 and 500 may be performed by a second node, and the present disclosure provides a second node that is adapted to perform any or all of the steps of the above discussed methods. The second node may comprise a physical node such as a computing device, server etc., or may comprise a virtual node. A virtual node may comprise any logical entity, such as a Virtualized Network Function (VNF) which may itself be running in a cloud, edge cloud or fog deployment. The second node may be operable to be instantiated in a cloud based deployment. In one example, the second node may be instantiated in a Cloud RAN deployment. In other examples, the second node may be instantiated in any physical or virtual server in a centralised or cloud based deployment. As discussed above, the second node may comprise a RAN node.

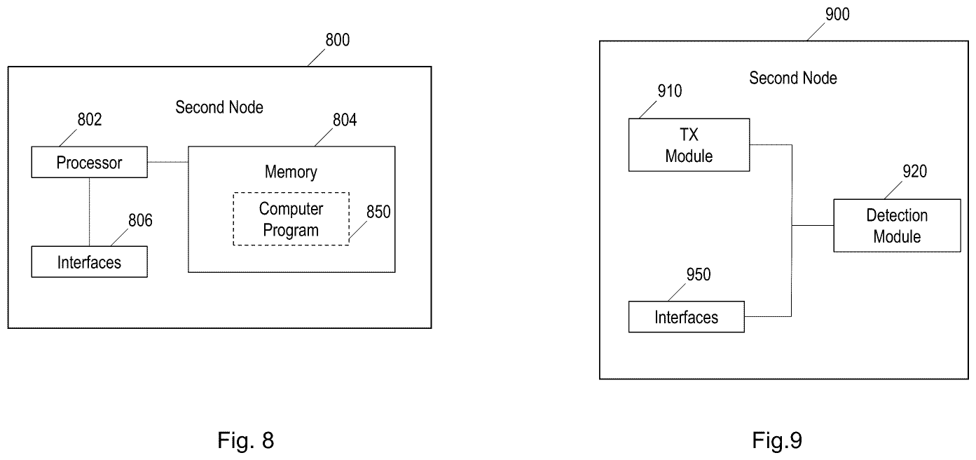

FIG. 8 is a block diagram illustrating an example second node 800 which may implement the method 400 and/or 500, as illustrated in FIGS. 4 and 5ai to 5b, according to examples of the present disclosure, for example on receipt of suitable instructions from a computer program 850. Referring to FIG. 8, the second node 800 comprises a processor or processing circuitry 802, and may comprise a memory 804 and interfaces 806. The processing circuitry 802 is operable to perform some or all of the steps of the method 400 and/or 500 as discussed above with reference to FIGS. 4 and 5ai to 5b. The memory 804 may contain instructions executable by the processing circuitry 802 such that the second node 800 is operable to perform some or all of the steps of the method 400 and/or 500, as illustrated in FIGS. 4 and 5ai to 5b. The instructions may also include instructions for executing one or more telecommunications and/or data communications protocols. The instructions may be stored in the form of the computer program 850. In some examples, the processor or processing circuitry 802 may include one or more microprocessors or microcontrollers, as well as other digital hardware, which may include digital signal processors (DSPs), special-purpose digital logic, etc. The processor or processing circuitry 802 may be implemented by any type of integrated circuit, such as an Application Specific Integrated Circuit (ASIC), Field Programmable Gate Array (FPGA) etc. The memory 804 may include one or several types of memory suitable for the processor, such as read-only memory (ROM), random-access memory, cache memory, flash memory devices, optical storage devices, solid state disk, hard disk drive, etc. The interfaces 806 may be operable to facilitate communication with a first node, and/or with other nodes or modules, over suitable communication channels.

FIG. 9 illustrates functional modules in another example of second node 900 which may execute examples of the methods 400 and/or 500 of the present disclosure, for example according to computer readable instructions received from a computer program. It will be understood that the modules illustrated in FIG. 9 are functional modules, and may be realized in any appropriate combination of hardware and/or software. The modules may comprise one or more processors and may be integrated to any degree.

Referring to FIG. 9, the second node 900 is for detecting, at a second node of a communication network, jamming signals on the Physical layer of the communication network. The second node 900 comprises a Transceiver module 910 for sending, to a first node of the communication network, a value of at least one parameter characterizing the second node. The second node further comprises a Detection module 920 for using a target ML model to detect jamming signals on the Physical layer of the communication network. The target ML model has been generated from a source ML model using Transfer Learning, and the source ML model has been trained by the first node using measurement data of radio signals in a coverage area of the first node. The second node 900 may further comprise interfaces 950, which may be operable to facilitate communication with a first node, and/or with other nodes or modules, over suitable communication channels.

FIGS. 2 to 5b discussed above provide an overview of methods which may be performed according to different examples of the present disclosure. These methods may be performed by a first and second node respectively, as illustrated in FIGS. 6 to 9. The methods enable the generation a target ML model for detection of jamming signals by one or more second nodes. There now follows a detailed discussion of how different process steps illustrated in FIGS. 2 to 5b and discussed above may be implemented. The functionality and implementation detail described below is discussed with reference to the modules of FIGS. 6 to 9 performing examples of the methods 200, 300, 400 and/or 500, substantially as described above.

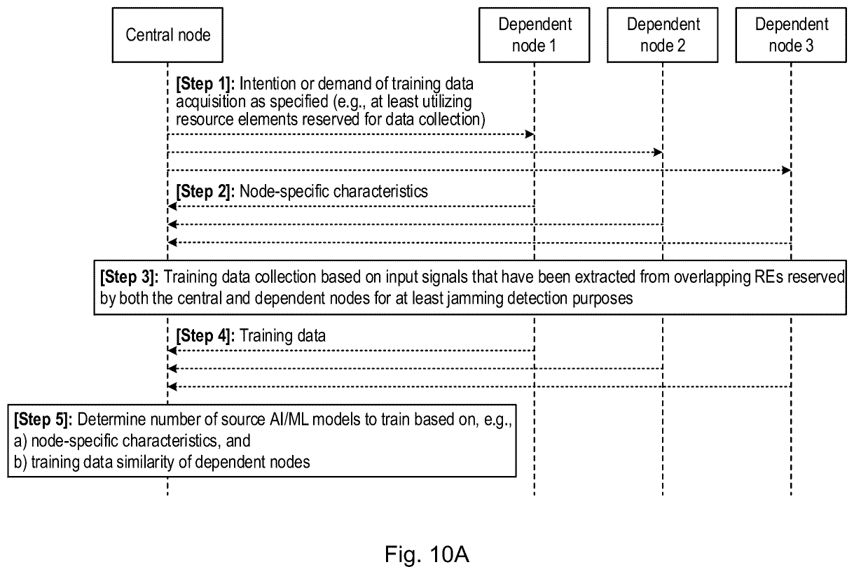

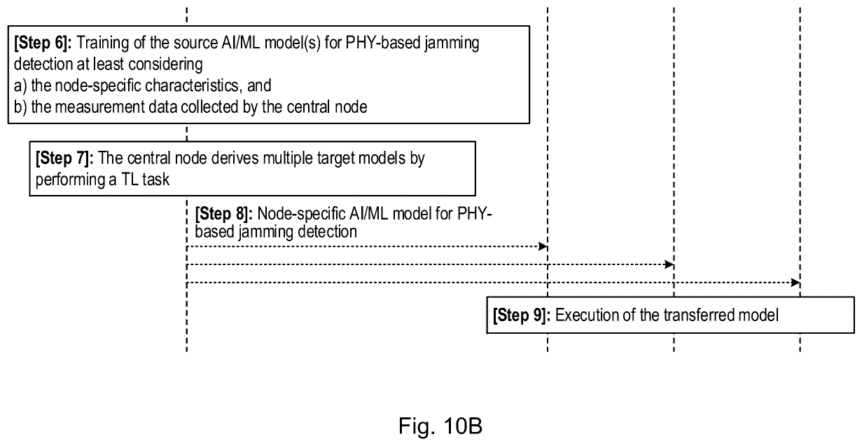

FIG. 10 is a sequence diagram illustrating a process flow for implementing examples of the methods 200, 300, 400 and/or 500. It will be appreciated that FIG. 10 represents only one example implementation, and consequently the order in which some steps are carried out may be changed, and certain steps may be omitted or substituted, depending upon how the method is initiated, and which implementation option are selected for a given deployment.

The process flow of FIG. 10 is carried out between a first node, which in the illustrated example is a central node such as a Macro eNodeB, Macro gNodeB or cloud server, and a plurality of second nodes, which in the illustrated example are dependent nodes, such as small cell eNBs, small cell gNBs, or UEs. The central node can exchange information with the dependent nodes via wired or wireless links. The steps of the process flow are described below, with reference to example steps of the methods 200, 300, 400, 500 which they may implement.

Step 1 (Steps 302i, 304i, 306i, 302ii, 304ii, 502i, 504i, 506i, 502ii, and/or 504ii of methods 300, 500): A central node communicates to dependent nodes its intention to start a data collection process at a specified point in time and/or that they should collect training data for jamming detection purposes at a specified point in time. The central node may require dependent nodes to reserve a subset of time/frequency REs for at least jamming detection purposes. In some examples, those REs will not have intended uplink transmissions from the associated UEs (i.e., they are empty REs). The central node may also reserve the same subset of REs for at least jamming detection purposes. In some examples, the central node may indicate the duration of the data collection process.

In some examples in which the central node is a macro basestation and the dependent node is a small cell basestation, the eNBs/gNBs can communicate using existing X2/Xn interfaces. For example, the macro basestation may build on existing inter-cell interference coordination (ICIC) signaling to prevent small cell basestations from transmitting in specific REs. In addition, the central node may indicate that measurement data should/will be collected during those REs for at least jamming detection purposes.

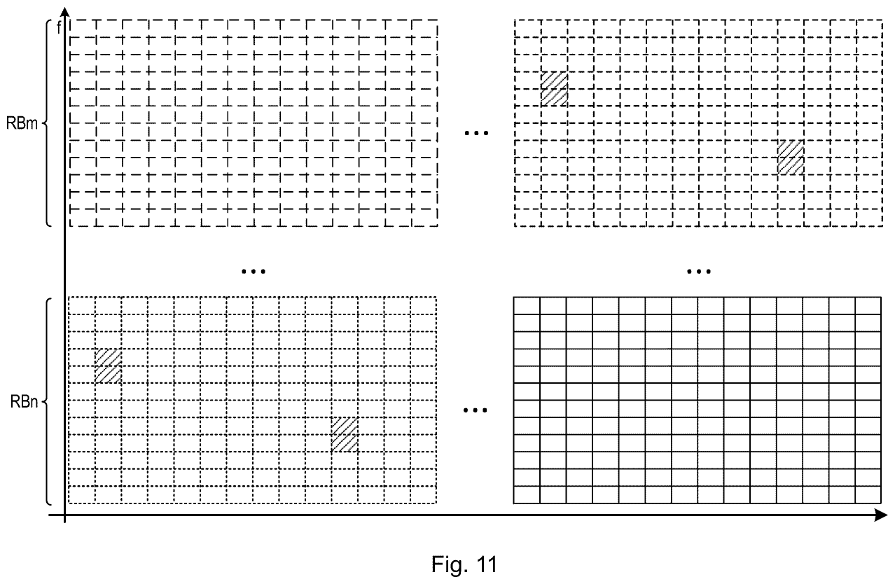

As illustrated in FIG. 11, in some examples, the subset of REs reserved for at least jamming detection purposes may be allocated in a limited bandwidth (for example, within a single physical resource block) and the frequency-domain location of these RE may alternate pseudo-randomly across time (for example, different physical resource blocks within the communication). FIG. 11 illustrates such alternating empty time/frequency resource elements for facilitating jamming detection. The pseudo-random allocation of the REs is particularly tailored to the application of narrowband jammer detection. The pseudo-random allocation facilitates detecting jammers in any part of the spectrum and prevents jammer countermeasures.

Step 2 (steps 210, 310i, 310ii, 410, 510i, and/or 510ii of methods 200, 300, 400, 500): The dependent nodes communicate node-specific characteristics to the central node where the training of at least the source ML model will be executed. In some examples, node-specific characteristics may include the wireless communication bandwidth, radio frequency properties like the noise figure, or the number of antennas. In some examples, the central node may explicitly request such information from a dependent node and indicate that it is requested for the training of ML models. In other examples, a dependent node may share the node-specific characteristics and explicitly or implicitly request the training and/or retraining of an ML model for PHY-based jamming detection.

Step 3 (steps 320, 512 of methods 300, 500): Central and dependent nodes collect measurement data for at least the training of ML model(s) for PHY-based jamming detection. Both central and dependent nodes collect measurement data at least on the subset of REs reserved as discussed in Step 1.

In some examples, the central node will not schedule transmissions in the REs on which measurement data is collected for use in training ML models for jamming detection purposes in Step 6. That is, the central node may refrain from scheduling transmissions on REs overlapping with the reserved REs discussed in Step 1. This differs from typical ICIC operations in which a central node uses the REs left empty by the small cell basestation for data transmission/reception purposes. It will be appreciated that the allocation of empty REs by both central and dependent nodes facilitates the transfer learning that enables generation of a target ML model from a source ML model, and improved performance of jamming detection, as it will make the training and inference data extracted from the source and target domains more similar. For the specific case in which the central node is a macro BS and the dependent node is a small cell BS, the advantage in removing useful network signals generated by associated devices from the training and inference data may be particularly significant. The signal distributions of useful network signals are substantially different for Macro and small cell BSs. Macro BSs are typically associated with UEs located hundreds of meters away and experiencing non-line-of-sight (NLOS) propagation conditions. In contrast, small cells are typically associated with UEs located tens of meters away and experiencing line-of-sight (LOS) propagation conditions. By ensuring that no useful network signals are present in the REs on which training data measurement and jamming detection are performed, it may be secured that the signals received in such REs will only contain measurements from devices belonging to other cells.

Step 4 (steps 325, 514 of method 300, 500): Measurement data from the dependent nodes can be transferred to the central node, if transfer learning is to take place at the central node.

Step 5 (steps 230, 330 of methods 200, 300): The central node determines the number of source ML models to train depending on the similarity of, for example:
a) the node-specific characteristics received in Step 2, and/or
b) the training data collected by the central node in Step 3, and/or
c) the training data received from the dependent nodes in Step 4.

In a first set of examples, the central node may train a plurality of source ML models, with each source model corresponding to a group of dependent nodes with similar or and/or identical node-specific characteristics and/or and with similar training data domains.

In a second set of examples, the central node will train a unique source ML model and generate a plurality of target ML models, with each target model corresponding to a group of nodes with similar and/or identical node-specific characteristics and/or and with similar training data domains.

For example, considering a case in which the central node is a macro BS with a large number of antennas, high-quality radio chains, and operating over a large bandwidth, and in which the dependent nodes comprise multiple small cell BSs with different numbers of antennas, communication bandwidths, and radio chain quality:
In the first set of examples, multiple source ML models for PHY-based jamming detection may be trained at the central node, each corresponding to a group of small cells with a similar number of antennas, radio chain quality, and communication bandwidths. Each source model will use input signals from a subset of antennas, over a smaller bandwidth, and introducing artificial noise to mimic the differences in radio chain quality.
In the second set of examples, a single source ML model for PHY-based jamming detection may be trained at the central node. To ensure generality, the model may be trained using input signals from a variety of different numbers of antennas corresponding to all or a subset of those found in the dependent nodes, with a variety of communication bandwidths corresponding to all or a subset of those found in the dependent nodes, and introducing artificial noise with a variety of powers to mimic the differences in radio chain quality of the dependent nodes.

Step 6 (Steps 240, 340 of method 200, 300): The central node trains the selected number of source ML model(s) as determined in Step 5, for example considering
a) the node-specific characteristics received in Step 2,
b) the measurement data collected by the central node using at least the reserved REs described in Step 3.

In some examples, the central node may access labels for its measurement data (for example binary labels: attack or not attack) so the trained source ML model is supervised. The training aims to learn a function from labelled training data to map input (IQ) samples to real classes/labels h: [symbol] , where h is a function or an element of a hypothesis space [symbol] , and [symbol] refers to a set of all possible functions. Generally, to obtain the best predictive function, the model is learned on a given source dataset by minimizing the expected risk of the source labelled data:

Rₛ(h)=E(x,y)˜Pₛ(x,y)[l(h(x),y)],

where P₃(x,y) is the source distribution and l(h(x),y) is the loss function. In some examples, this model will be a neural network.

In some examples, the central node may not access labels for the measurement data and so the trained source ML model is unsupervised. In these examples, the training could be based on generative models where the data distribution is estimated. Once the distribution is estimated, a classifier could be executed to determine if a new input sample is coming from the same distribution or not. If a sample is not considered to belong to the same distribution the presence of a jammer may be inferred. To estimate the distribution, some examples may use an autoregressive model in which the joint distribution can be modelled as a product of one-dimensional conditional densities using the probability chain rule, i.e., ∀x∈R^{d}, where the probability distribution of x is given by

$$p ( x ) = {\prod }_{i = 1}^{d} p ( {x}_{i} \vert {x}^{i < d} )$$

Step 7 (steps 250, 350 of methods 200, 300): The central node derives multiple target models by performing a TL task.

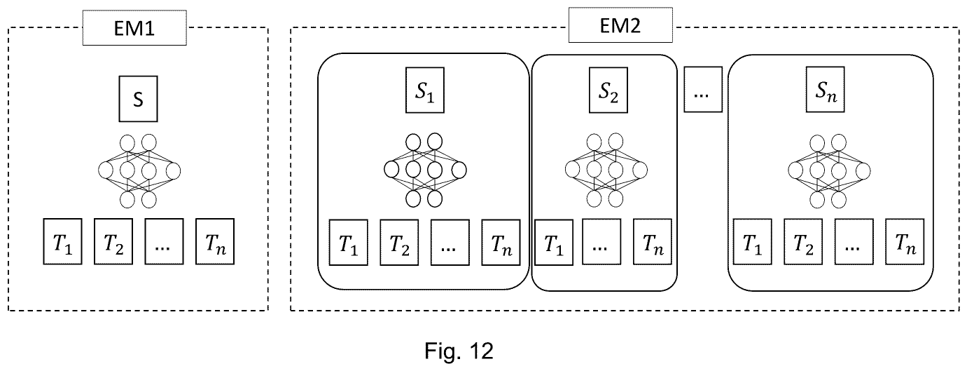

In some examples in which Step 4 is executed (i.e., the measurement data from dependent nodes is available at the central central), the TL may be conducted as a single-source multi-target task. As illustrated in FIG. 12, in the first set of examples, the TL may be conducted from multiple source ML models to a plurality of target ML models. In the second set of examples, the TL will be conducted from a unique source ML model to a plurality of target ML models.

In examples in which the source ML model(s) is(are) supervised:
If the target domain data is labelled (i.e., the measurement data from the second nodes), supervised TL tasks can be executed. These TL tasks may be based on, for example, freezing some layers at the source model (if the source model is a Neural Network), and then retraining the remaining layers in order to fine tune the model according to the new data
If the target domain data is unlabelled, unsupervised transfer learning tasks can be executed. These TL tasks may be based on, for example, domain adversarial neural networks (DANNs) or joint adaptation networks (JANs).

In examples in which the source ML model(s) is(are) unsupervised, the target domain data can again be either labelled or unlabelled. In these examples, the TL can be conducted by mapping the source space to the target space via a projection (such as subspace alignment) or via function (such as optimal transport).

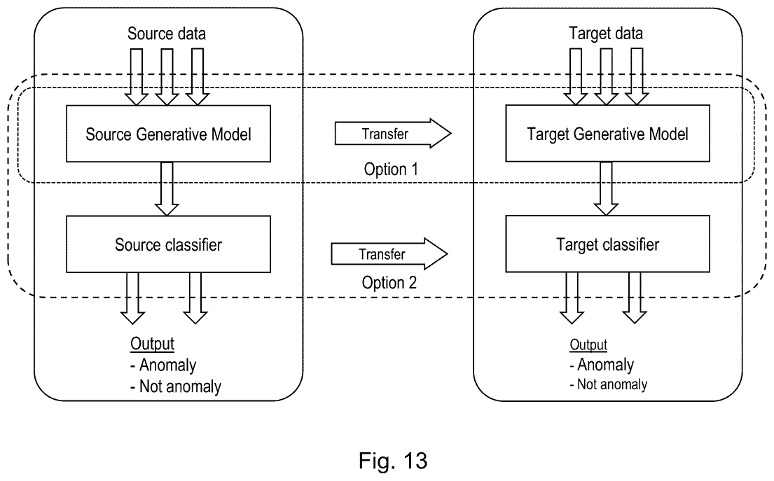

As illustrated in FIG. 13, in some examples, the TL task may only be executed on the generative model. In these examples, the classifier for the attack detection may be retrained. In other examples, the TL can be executed on both generative model and the classifier by adapting both according to the target domain data.

In some examples in which Step 4 is not executed (i.e., the measurement data from dependent nodes is not available at the central central), the central node may provide the appropriate source ML model to the dependent nodes. In these examples, dependent nodes will execute the TL task using their locally available measurement data.

Step 8 (steps 260, 360, 516 of methods 200, 300, 500): The central node provides the trained target ML model for PHY-based jamming detection to the dependent nodes.

If TL is to be performed at the dependent nodes, then the central node may provide the source ML model to the dependent nodes as opposed to the target ML model (step 515 of method 500).

Step 9 (steps 520, 370 of methods 500, 300): The dependent nodes then execute the target ML model to evaluate whether a jammer is present or not. In examples in which the central and the dependent nodes did not schedule uplink data transmissions in a subset of time/frequency REs for training the ML model, the dependent nodes will follow the same criteria when executing the trained ML jamming detection model and use at least the measurements acquired in those REs for model inference purposes. In some examples, the central node may also use at least one source ML model for jamming detection. The central node may use measurement data of radio signals in a coverage area of at least one of the dependent nodes to update training of the source ML model.

Examples of the present disclosure thus provide a method that enables the transfer of ML models for PHY-based jamming detection across network nodes with different characteristics. The models executed by the dependent node(s) are generated using transfer learning and taking account of node-specific characteristics of the dependent node. A source ML model for the jamming detection models may be trained using input signals that have been extracted from overlapping REs reserved by both the central and the dependent nodes for at least jamming detection purposes. It will be appreciated that while the 5G NR standard considers reserving empty REs for interference measurement purposes (CSI-IMs), the decision on the reserved REs is typically adopted independently on a per-BS basis. Intuitively, BSs will allocate non-overlapping REs for this purpose, as the objective of CSI-IMs is to measure the interference present in the network in regular conditions.

Examples of the present disclosure therefore enable provision of ML models for jamming detection that are tailored to individual nodes or groups of nodes in the network, so as to enhance their accuracy, without excessive transfer of training data, and without requiring extensive computing and memory resources in the nodes for training. Examples of the present disclosure also ensure increased likelihood of training of ML models with data incorporating the presence of jammers, and reduced training time and complexity of the ML models for PHY-based jamming detection at the target nodes. Examples of the present disclosure may be of particular assistance in private networks, where an adequate detection of jammers is critical.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative examples without departing from the scope of the appended claims or numbered examples. The word “comprising” does not exclude the presence of elements or steps other than those listed in a claim or example, “a” or “an” does not exclude a plurality, and a single processor or other unit may fulfil the functions of several units recited in the claims or numbered examples. Any reference signs in the claims or numbered examples shall not be construed so as to limit their scope.

1. A method for facilitating detection, at a plurality of second nodes of a communication network, of jamming signals on the Physical layer of the communication network, the method, performed by a first node of the communication network, comprising:
receiving, from each of the plurality of second nodes, a value of at least one parameter characterizing the respective second node;
obtaining measurement data of radio signals in a coverage area of the first node;
determining, from at least the received parameter values, a number of source Machine Learning, ML, models to be trained to detect jamming signals;
training the determined number of source ML models using the obtained measurement data of radio signals in a coverage area of the first node;
for each trained source ML model, causing a target ML model to be generated from the source ML model using a Transfer Learning process; and
causing each of the plurality of second nodes to use at least one of the target ML models to detect jamming signals on the Physical layer of the communication network.

2. A method as claimed in claim 1, wherein each of the trained source ML models corresponds to a subset of the plurality of second nodes, and wherein, for each trained source ML model, causing a target ML model to be generated from the source ML model using Transfer Learning comprises using, for the Transfer Learning, measurement data of radio signals in a coverage area of second nodes belonging to the subset to which the source ML model corresponds.

3. A method as claimed in claim 2, further comprising instructing each of the plurality of second nodes to reserve specific Resource Elements, REs, for detection of jamming signals, and wherein obtaining measurement data of radio signals in a coverage area of the first node comprises obtaining measurement data for the REs that the plurality of second nodes have been instructed to reserve for jamming detection.

4. A method as claimed in claim 3, further comprising abstaining from scheduling transmission of communication network data or control signals on the REs reserved by the second nodes for jamming detection.

5. A method as claimed in claim 3, wherein the measurement data of radio signals in a coverage area of second nodes that is used for Transfer Learning comprises measurement data collected on the reserved REs.

6. A method as claimed in claim 3, wherein causing each of the plurality of second nodes to use at least one of the target ML models to detect jamming signals on the Physical layer of the communication network comprises causing each of the plurality of second nodes to use at least one of the target ML models to detect jamming signals on the reserved REs.

7. A method as claimed in claim 3, wherein the specific REs to be reserved for detection of jamming signals are located within a defined bandwidth, and wherein the frequency domain location of the reserved REs alternates pseudo-randomly across time.

8. A method as claimed in claim 1, wherein, for each trained source ML model, causing a target ML model to be generated from the source ML model using Transfer Learning comprises at least one of generating a target ML model using Transfer Learning, or providing the source ML model to at least one of the plurality of second nodes, wherein the at least one of the plurality of second nodes generates a target ML model using Transfer Learning.

9. A method as claimed in claim 1, wherein causing each of the plurality of second nodes to use at least one of the target ML models to detect jamming signals on the Physical layer of the communication network comprises at least one of providing the target ML models to the plurality of second nodes, or instructing the plurality of second nodes to use a target ML model once generated.

10. A method as claimed in claim 1, wherein the at least one parameter characterizing the respective second node comprises at least one of:
a capability of the second node
an operational characteristic of the second node;
a radio environment characteristic of the second node.

11. A method as claimed in claim 1, wherein determining, from at least the received parameter values, a number of source ML models to be trained to detect jamming signals comprises:
classifying the plurality of second nodes into a number of categories according to their similarity as represented by the received parameter values, wherein the number of categories comprises the number of source ML models to be trained.

12. A method as claimed in claim 1, further comprising:
receiving, from at least some of the plurality of second nodes, measurement data of radio signals in a coverage area of second nodes.

13. A method as claimed in claim 12, wherein determining a number of source ML models to be trained to detect jamming signals comprises determining the number of source ML models from at least the received parameter values and the received measurement data of radio signals in a coverage area of second nodes.

14. A method as claimed in claim 1, wherein training the determined number of source ML models using the obtained measurement data of radio signals in a coverage area of the first node comprises:
for each source ML model to be trained, using a subset of the obtained measurement data of radio signals in a coverage area of the first node to train the source ML model, wherein the subset of measurement data is selected to represent measurement data of radio signals in a coverage area of a subset of the plurality of second nodes.

15. A method as claimed in claim 1, wherein the source ML model comprises a prediction function operable to classify a detected radio signal as being either a jamming attack or not a jamming attack, wherein the measurement data of radio signals in a coverage area of the first node includes labels classifying the measured signals as a jamming attack or not a jamming attack, and wherein training the determined number of source ML models using the obtained measurement data of radio signals in a coverage area of the first node comprises using a Supervised Learning method.

16. A method as claimed in claim 15, wherein measurement data of radio signals in a coverage area of second nodes belonging to a subset of the plurality of second nodes to which the source ML model corresponds is available at the first node, and wherein causing a target ML model to be generated from the source ML model using Transfer Learning comprises:
performing at least one of supervised or unsupervised Transfer Learning to generate at least one target ML model from the source ML model.

17. A method as claimed in claim 1, wherein training the determined number of source ML models using the obtained measurement data of radio signals in a coverage area of the first node comprises using an Unsupervised Learning method, and wherein the source ML model comprises:
a generative model operable to estimate the data distribution of non jamming signals from the measurement data of radio signals in a coverage area of the first node; and
a prediction function operable to classify a detected radio signal belonging or not belonging to the estimated data distribution.

18. A method as claimed in claim 17, wherein measurement data of radio signals in a coverage area of second nodes belonging to a subset of the plurality of second nodes to which the source ML model corresponds is available at the first node, and wherein causing a target ML model to be generated from the source ML model using Transfer Learning comprises:
using supervised or unsupervised Transfer Learning to generate at least one of:
a target generative model to estimate the data distribution of non jamming signals; or
a target generative model to estimate the data distribution of non jamming signals and a target prediction function operable to classify a detected radio signal belonging or not belonging to the estimated data distribution.

19. A method for detecting, at a second node of a communication network, jamming signals on the Physical layer of the communication network, the method, performed by the second node of the communication network, comprising:
sending, to a first node of the communication network, a value of at least one parameter characterizing the second node; and
using a target ML model to detect jamming signals on the Physical layer of the communication network;
wherein the target ML model has been generated from a source ML model using Transfer Learning,
and wherein the source ML model has been trained by the first node using measurement data of radio signals in a coverage area of the first node.

20-31. (canceled)

32. A first node in a communication network, the first node for facilitating detection, at a plurality of second nodes of the communication network, of jamming signals on the Physical layer of the communication network, the first node comprising processing circuitry configured to cause the first node to:
receive, from each of the plurality of second nodes, a value of at least one parameter characterizing the respective second node;
obtain measurement data of radio signals in a coverage area of the first node;
determine, from at least the received parameter values, a number of source Machine Learning, ML, models to be trained to detect jamming signals;
train the determined number of source ML models using the obtained measurement data of radio signals in a coverage area of the first node;
for each trained source ML model, cause a target ML model to be generated from the source ML model using Transfer Learning; and
cause each of the plurality of second nodes to use at least one of the target ML models to detect jamming signals on the Physical layer of the communication network.

33-35. (canceled)
